(19) United States
(12) Patent Application Publication
(10) Pub. No.: US 2025/0325093 A1
(43) Pub. Date: Oct. 23, 2025

(54) ACCESSORIES FOR MOBILE ELECTRONIC DEVICES

(71) Applicant: PopSockets LLC, Boulder, CO (US)

(72) Inventors: Tark Abed, Boulder, CO (US); Alexander Dzigurski, Boulder, CO (US)

(21) Appl. No.: 19/217,722

(22) Filed: May 23, 2025

Related U.S. Application Data
(63) Continuation of application No. 17/377,697, filed on Jul. 16, 2021.
(60) Provisional application No. 62/794,305, filed on Jan. 18, 2019.
(60) Provisional application No. 62/906,361, filed on Sep. 26, 2019.

(51) Int. Cl. A45F 5/00; F16M 13/04; H04M 1/04

(52) U.S. Cl. CPC A45F 5/00; F16M 13/04; H04M 1/04; A45F 5/1516; A45F 5/1525

(57) ABSTRACT

An accessory is configured to provide grip and kickstand functionality for a mobile electronic device. The accessory includes a pivotable frame member comprising a base member configured to detachably attach to a rear surface of the mobile electronic device or to a rear surface of a case of the mobile electronic device, and a pivotable arm coupled to the base member at a hinge portion. The pivotable arm pivots along the hinge portion between at least a closed configuration and an open configuration, where the pivotable arm comprises a base-facing surface and an opposite accessory-facing surface. The accessory includes a grip accessory detachably coupled to the accessory-facing surface of the pivotable arm. At least a portion of the pivotable arm of the pivotable frame member is configured in an annular shape. The base member of the pivotable frame member may also be configured in an annular shape.

### CROSS-REFERENCE TO RELATED APPLICATIONS

This application is a continuation of U.S. application Ser. No. 17/377,697, filed on Jul. 16, 2021, which is a National Stage application of PCT/US2020/014125, filed on Jan. 17, 2020, which claims the benefit of U.S. Provisional Patent Application No. 62/794,305, filed Jan. 18, 2019, and U.S. Provisional Patent Application No. 62/906,361, filed Sep. 26, 2019, the entire contents of each of which are hereby incorporated herein by reference.

### FIELD OF THE DISCLOSURE

The present disclosure generally relates to expandable devices and, more particularly, to expandable devices that can be attached to a foldable electronic device or a case for a foldable electronic device and used as a grip, a stand, or for other purposes.

### BACKGROUND

Portable electronic devices, such as tablets and smart phones, are often housed in protective covers or cases in order to protect the device from damage, to provide a grip for handling the device, and/or to provide a stand for propping the device on a surface. Expandable devices and accessories, which may be attached directly to the device or to the case protecting the device, are used for a variety of functions, including propping the device on a surface and providing an expandable grip for handling the device. The expandable devices are typically positioned on and/or coupled to a rear surface of the portable electronic device to allow a user to securely grip the device, and may have decorative buttons, which may display logos, decals, symbols, or other artistic renderings. In some cases, portable electronic devices may include folding and/or expanding mechanisms that can selectively modify an overall configuration and/or dimension of the device. Such mechanisms may hinder and/or limit placement of the expandable accessory devices. Further, as foldable electronic devices become increasingly common, technological advancements such as additional sensors, cameras and/or lens arrays, and the like may be positioned at varying locations on the device that may potentially impact placement of the accessory device.

### SUMMARY

In accordance with some examples, an accessory is configured to provide grip and kickstand functionality for a mobile electronic device. The accessory may include a pivotable frame member comprising a base member configured to detachably attach to a rear surface of the mobile electronic device or to a rear surface of a case of the mobile electronic device, and a pivotable arm coupled to the base member at a hinge portion. The pivotable arm may be configured to pivot along the hinge portion between at least a closed configuration and an open configuration, where the pivotable arm comprises a base-facing surface and an opposite accessory-facing surface. The accessory may further include a grip accessory detachably coupled to the accessory-facing surface of the pivotable arm.

In certain embodiments, the at least a portion of the pivotable arm of the pivotable frame member is configured in an annular shape. The base member of the pivotable frame member may also be configured in an annular shape.

In one or more embodiments, the pivotable arm may be positionable as a kickstand for the mobile electronic device when in the open configuration.

In one or more embodiments, the base-facing surface of the pivotable arm may be adjacent to the base member when the pivotable arm is in the closed configuration.

In one or more embodiments, the grip accessory is movable between an expanded configuration and a collapsed configuration.

In one or more embodiments, the grip accessory in the expanded configuration is configured to be grasped by a user to securely hold the mobile electronic device when the pivotable arm is in the closed configuration.

In one or more embodiments, at least a portion of the grip accessory expands away from the accessory-facing surface of the pivotable arm when moving from the collapsed configuration to the expanded configuration, and contracts towards the accessory-facing surface of the pivotable arm when moving from the expanded configuration to the collapsed configuration.

In one or more embodiments, the grip accessory comprises a top side, a bottom side, and a coupling portion, and wherein the top side of the grip accessory expands away from the accessory-facing surface of the pivotable arm when moving from the collapsed configuration to the expanded configuration, and contracts towards the accessory-facing surface of the pivotable arm when moving from the expanded configuration to the collapsed configuration.

In one or more embodiments, a securing mechanism is configured to retain the pivotable arm in the closed configuration.

In one or more embodiments, the grip accessory comprises an expandable mechanism which is configured to resiliently retain the grip accessory in the closed configured and expanded configuration, respectively.

### BRIEF DESCRIPTION OF THE DRAWINGS

The above needs are at least partially met through provision of the grip for a foldable electronic device described in the following detailed description, particularly when studied in conjunction with the drawings, wherein:

FIG. 1 illustrates a right-side perspective view of an example expandable device coupled to a foldable electronic device while being in a first configuration;

FIG. 2 illustrates a left side perspective view of the expandable device of FIG. 1 in the first configuration;

FIG. 3 illustrates a left side perspective view of the expandable device of FIGS. 1 and 2 while being in a second configuration;

FIG. 4 illustrates a rear perspective view of the expandable device of FIGS. 1-3 coupled to the foldable electronic device in a transitory state while the expandable device is in the second configuration;

FIG. 5 illustrates a rear perspective view of the example expandable device of FIGS. 1-4 coupled to the foldable electronic device in an unfolded state while the example expandable device is in the first configuration;

FIG. 6 illustrates a zoomed-in view of the example expandable device of FIGS. 1-5;

FIG. 7 illustrates a right-side perspective view of the example expandable device of FIGS. 1-6 in the second configuration;

FIG. 8 illustrates a front perspective view of another example expandable device coupled to a foldable electronic device in a first configuration;

FIG. 9 illustrates a rear perspective view of the example expandable device of FIG. 8 coupled to a foldable electronic device while being in a first configuration

FIG. 10 illustrates a rear perspective view of the example expandable device of FIGS. 8 and 9 coupled to a foldable electronic device in the first configuration;

FIG. 11 illustrates a rear perspective view of the example expandable device of FIGS. 8-10 coupled to a foldable electronic device in a second configuration;

FIG. 12 illustrates a rear perspective view of the example expandable device of FIGS. 8-11 coupled to the foldable electronic device in a transitory state while the example expandable device is in the second configuration;

FIG. 13 illustrates a rear perspective view of the example expandable device of FIGS. 8-12 coupled to the foldable electronic device in an unfolded state while the example expandable device is in the first configuration;

FIG. 14 illustrates a front perspective view of another example expandable device coupled to a foldable electronic device;

FIG. 15 illustrates a rear perspective view of the example expandable device of FIG. 14 coupled to a foldable electronic device while being in an expanded configuration;

FIG. 16 illustrates a rear perspective view of the example expandable device of FIGS. 14 and 15 coupled to a foldable electronic device while being in a collapsed configuration;

FIG. 17 illustrates a front perspective view of the third example expandable device of FIGS. 14-16 coupled to a foldable electronic device in an unfolded state;

FIG. 18 illustrates a rear perspective view of the example expandable device of FIGS. 14-17 coupled to a foldable electronic device in an unfolded state;

FIG. 19 illustrates a side elevation view of an example expandable device in a collapsed configuration;

FIG. 20 illustrates a side elevation view of the example expandable device of FIG. 20 in an expanded configuration; and

FIGS. 21A-21C illustrate various views of an expandable device consistent with the expandable device illustrated in FIGS. 8-13.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various versions of the present invention. Also, common but well-understood elements that are useful or necessary in a commercially feasible version are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, expandable devices for foldable electronic devices are provided that include a platform or frame member and a button that is movable relative to the frame member between a collapsed configuration and an expanded configuration. Traditionally, these expandable devices are positioned on and/or coupled to a rear surface of the foldable electronic device and allow a user to securely grip the device. The expandable device further may act as a stand or platform for the device as well as function as a cord-retention mechanism for headphones or other cables.

Foldable portable electronic devices may be configured to fold backwards, such that the rear surface of the device becomes sandwiched between the front surface. In other cases, foldable portable devices are configured to open in a wallet-type manner. In still other cases, foldable portable devices may be configured to change form in response to a bending-or folding-force applied by the user. In each of these cases, such bending or folding creates handling, ergonomic and/or weight-distribution challenges for the user. To that end, one aspect of the disclosure is to provide an expandable device that is configured to be effectively used as a grip, a stand, or to otherwise facilitate handling of foldable portable electronic devices. For example, the expandable devices described herein allows a button, usable as a grip, to move to various locations or regions of the expandable device in order to be positioned outside of the physical space occupied by the foldable portable electronic device when in the folded position. In other words, the expandable devices described herein accommodate for the folding of the device, and may still be used as a gripping and/or storage mechanism when the device is in the folded position.

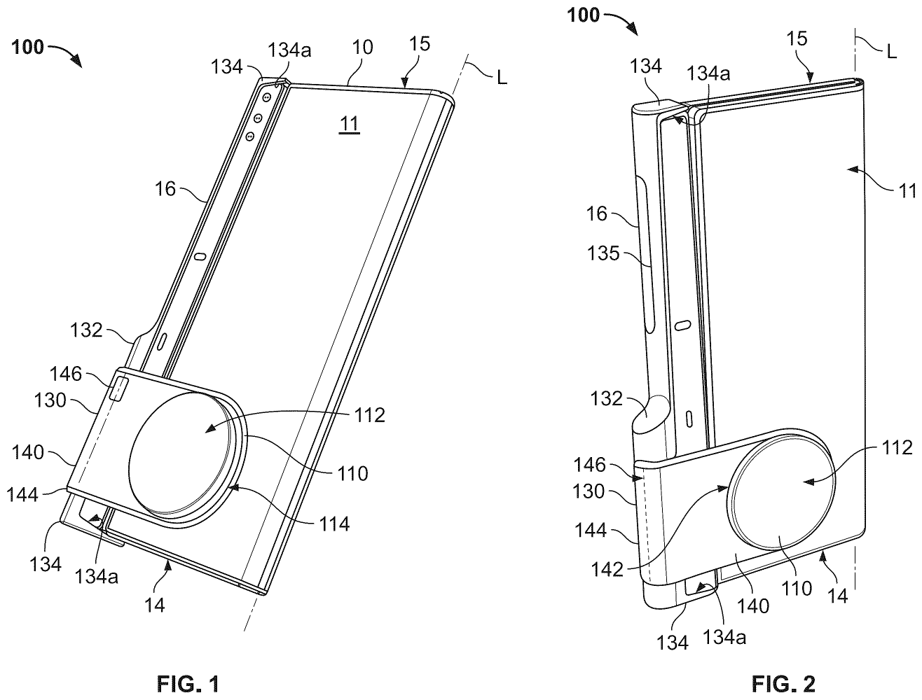

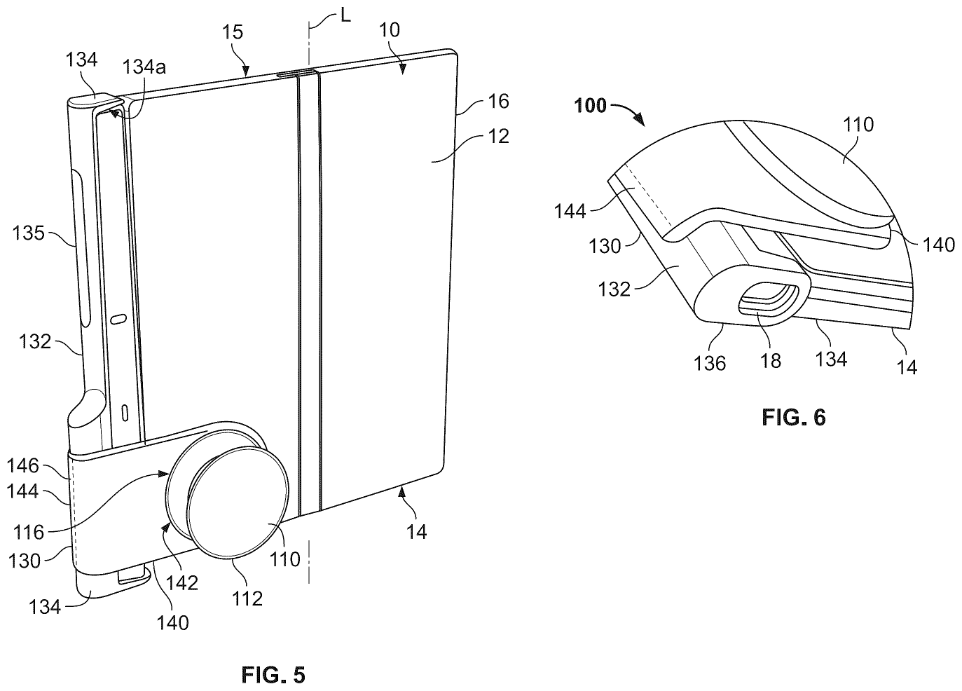

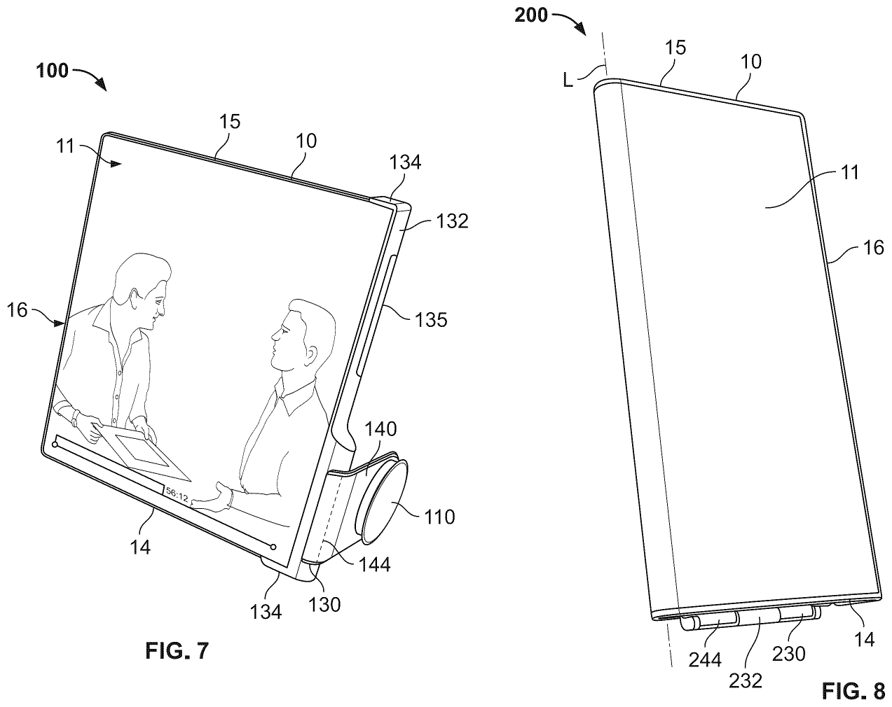

With reference now to the figures, one example of an expandable device 100 coupled to a foldable electronic device 10 is shown in FIGS. 1-7. Briefly, the foldable electronic device 10 includes a front surface 11 that includes a screen or display, a rear surface 12 (FIGS. 4 and 5), a lower surface 14, an upper surface 15, and side surfaces 16. Each of the lower surface 14, the upper surface 15, and the side surfaces 16 extend between the front and rear surfaces 11, 12. The foldable electronic device 10 may be in the form of a foldable cellular telephone having a foldable screen or screens disposed on the front surface 11 that may be selectively bifurcated in a manner that reduces the overall screen size by approximately half or any other fraction. The foldable electronic device 10 may use any number of folding mechanisms to cause the device to be folded about a folding axis L.

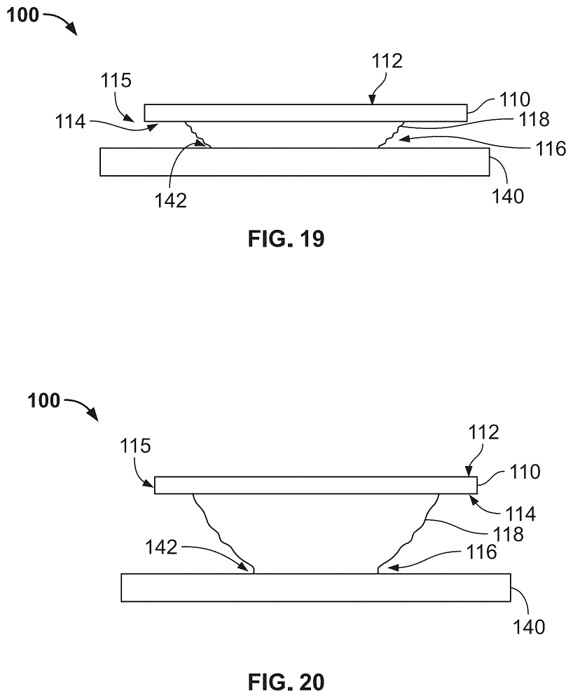

As illustrated in FIGS. 1-7, 19, and 20, The expandable device 100 includes a button 110 having a top side 112, a bottom side 114, and a coupling portion 116, and further includes a pivotable frame member 130 having a base member 132 and a pivotable arm 140 coupled thereto. As illustrated in FIGS. 19 and 20, the coupling portion 116 of the button 110 further includes a collapsible and/or expandable mechanism 118 operably coupled to the button 110. In the illustrated example, the coupling portion 116 is carried by, formed integrally with, and/or attached to the expandable mechanism 118 to selectively release or couple the button 110 to the pivotable frame member 130, and, more specifically, to the pivotable arm 140.

The expandable mechanism 118 generally facilitates movement of the accessory device 100 between an expanded configuration and a collapsed configuration, and acts to retain the accessory device 100 in the desired configuration (expanded or collapsed) when coupled to a portable electronic device such as the foldable electronic device 10. The expandable mechanism 118 may take the form of an outer case, enclosure, shell, deformable cover, etc., and may include a resilient member (e.g., a bistable coil spring) that is arranged between the button 110 and the pivotable arm 140.

As previously noted, the button 110 includes the top or upper side 112, the bottom or inner side 114, and further includes a rim or edge 115. The button 110 is operably coupled to the expandable mechanism 118. The button 110 may have an annular shape. In other examples, however, the button 110 may have a rectangular, square, triangular, irregular, or other shape. The button 110 is preferably constructed from metal or plastic material, though other suitable materials can be used.

As stated, the button 110 is removable from the expandable device 100, and may be selectively secured to the pivotable arm 140 of the expandable device 100. The button 110 may have artistic value (e.g., the button 110 may include an artistic rendering, a logo, a symbol, text, or a decal), the button 110 may provide a grip that allows a user to slide their fingers between the bottom side 114 and the pivotable arm 140 when the expandable mechanism 118 is in the expanded configuration (when, for example, the button 110 is coupled to the foldable electronic device 10) such that the top side 112 of the button 110 is disposed adjacent to the palm of the user's hand, and may also provide a space in which a cord, such as a cord for earphones, may be wrapped and stored around a portion of the expandable mechanism 118 and/or the pivotable arm 140.

Generally, the expandable mechanism 118 is used to move from the expanded configuration to the collapsed configuration by overcoming any biasing forces applied by resilient members. This may be accomplished by grabbing or grasping the button 110 and moving (e.g., pushing) the button 110 towards the pivotable arm 140. The expandable device 100 may include any number of retaining components and/or locking mechanisms to maintain the expandable device 100 in the collapsed configuration. The button 110 may be positioned in the expanded configuration by grasping or pulling the button 110 away from the pivotable arm 140 with a sufficient force to overcome the force of any retaining components used to secure the expandable device 100 in the collapsed configuration. Upon doing so, if the expandable device 100 is equipped with a resilient member or members, the button 110 will be urged towards, and maintained in, an expanded configuration.

Returning to FIGS. 1-7, the pivotable frame member 130 may have any desired shape (e.g., an elongated, generally rectangular shape) and is preferably constructed from a metal or a plastic material, though other suitable materials (e.g., cardboard) can be used. Generally speaking, the base member 132 is dimensioned to avoid interference with any electronic components such as, for example, sensors, speakers, camera modules, etc. disposed near the edge 16 of the foldable electronic device 10. In the illustrated example, the base member 132 includes a device coupling portion in the form of a finger or fingers 134 that extend or protrude outwardly from the base member 132. The fingers 134 may define a cavity 134a in which a portion of the side surface 16 of the foldable electronic device 10 may be at least partially disposed. The base member 132 may have an overall length (or any other dimension) that corresponds to an overall height (or any other dimension) of the foldable electronic device 10. As such, the finger or fingers 134 may be positioned to create a frictional coupling between the base member 132 and the foldable electronic device 10 to secure the base member 132 to the foldable electronic device 10. Other types of couplings such as adhesives, notches, and the like may be used. The base member 132 may further include an opening or slot 135 positioned to allow controls (e.g., a power button, a volume button or buttons, etc.) disposed on the foldable electronic device 10 to be accessed.

The pivotable arm 140 includes a button coupling portion 142 and a hinge portion 144. In some examples, the button coupling portion 142 may be in the form of an opening that engages the coupling portion 116 of the button 110. In other examples, the button coupling portion 142 may be in the form of a quick release mechanism (not illustrated) that allows the button 110 to releasably couple with the pivotable arm 140. Other examples and configurations are possible.

In some approaches, the hinge portion 144 may be in the form of a curved portion corresponding to a curvature of the base member 132, or may include a hinge assembly that allows the pivotable arm 140 to pivot relative to the base member 132. In either of these examples, the hinge portion 144 may include a release mechanism that allows the pivotable arm 140 to be decoupled from the base member 132. In some examples, all or a portion of the hinge assembly may be carried by the base member 132.

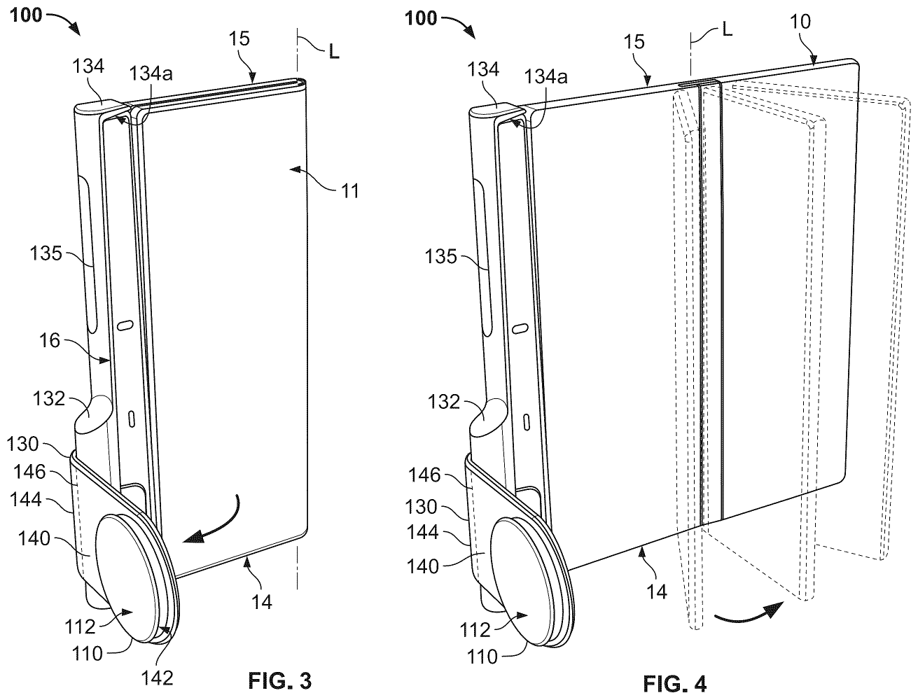

The pivotable arm 140 is pivotable between a first configuration (FIGS. 1, 2, and 5) and a second configuration (FIGS. 3, 4, and 7). When the pivotable arm 140 is in the first configuration, the pivotable arm 140, and thus the button 110, is positioned adjacent to and/or near the foldable electronic device 10 (e.g., the front surface 11 or the rear surface 12). As previously stated, the button 110 may be positioned in an expanded or a collapsed configuration as desired. So configured, and as illustrated in FIGS. 1 and 2, a user may hold the button 110, and thus the foldable electronic device 10 while the foldable electronic device 10 is in a folded state. In some examples, the pivotable arm 140 may act as a securement mechanism that restricts and/or prevents the foldable electronic device 10 from moving to an unfolded configuration.

When the user wishes to unfold the foldable electronic device 10, as illustrated in FIG. 3, the user may pivot the pivotable arm 140 to the second configuration. In this second configuration, the pivotable arm 140 no longer restricts and/or prevents the foldable electronic device 10 from being unfolded, as the pivotable arm 140 provides ample clearance for the foldable electronic device 10 to move between folded and unfolded configurations as shown in FIG. 4. Upon the foldable electronic device 10 being unfolded, the pivotable arm 140 may be positioned in either the first configuration (FIG. 5) or the second configuration (FIG. 6) as desired. When the pivotable arm 140 is positioned in the first configuration, a user may grasp the button 110 to securely hold the foldable electronic device 10. Additionally, when the pivotable arm 140 is positioned in the second configuration, the pivotable arm 140 may serve as a kickstand to prop and/or retain the foldable electronic device 10 in an upright position.

In some examples, the hinge portion 144 may additionally include a locking mechanism 146 which may be operably coupled to the base member 132 and/or the pivotable arm 140. The locking mechanism 146 selectively retains the pivotable arm in the first and/or the second configurations. For example, the locking mechanism 146 may be in the form of a resilient member that exerts an urging force on the pivotable arm 140 that retains the pivotable arm 140 in either the first and/or the second configuration. In some examples, the resilient member may be a bistable element that selectively exerts opposing forces to retain the pivotable arm 140 in the first and second configurations. Other examples are possible.

In some examples, the expandable device 100 may include any number of additional features. For example, as illustrated in FIG. 6, the base member 132 may include an electrical pass through 136, which may be used to allow the device to be charged when using the expandable device 100. The electrical pass through 136 may include an internal connector (not illustrated) that is inserted into a charging port 18 on the foldable electronic device 10. The electrical pass through 136 may include any number of electrical and/or mechanical components that assist in supplying a power source to the foldable electronic device 10. Further, in some examples, the base member 132 may carry a battery or a battery pack that may provide a power source to the foldable electronic device 10. Other examples are possible.

Another example of an expandable device 200 coupled to a foldable electronic device is illustrated in FIGS. 8-13. It will be appreciated that the expandable device 200 illustrated in FIGS. 8-13 may include similar features to the expandable device 100, and accordingly, elements illustrated in FIGS. 8-13 are designated by similar reference numbers indicated in FIGS. 1-7 increased by 100. Accordingly, these features will not be described in substantial detail. Further, it is appreciated that any of the elements described with regards to the expandable device 100 may be incorporated into the expandable device 200.

Expandable device 200 comprises a pivotable frame member 230 having a base member 232 and a pivotable arm 140 coupled thereto. In the embodiment of FIGS. 8-13, the base member 232 is in the form of a generally flat, planar member having a coupling portion in the form of a facing surface 234 that couples to the rear surface 12 of the foldable electronic device 10. However, it should be appreciated that, as with the pivotable frame member 130 of FIGS. 1-7, the pivotable frame member 230 may have any desired shape and is preferably constructed from a metal or a plastic material, though other suitable materials (e.g., cardboard) can be used. Generally speaking, the base member 232 is dimensioned to avoid interference with any electronic components such as, for example, sensors, speakers, camera modules, etc. In some examples, an adhesive may be used to secure the facing surface 234 of the base member 232 to the rear surface 12 of the foldable electronic device 10. Other examples of suitable coupling approaches are possible.

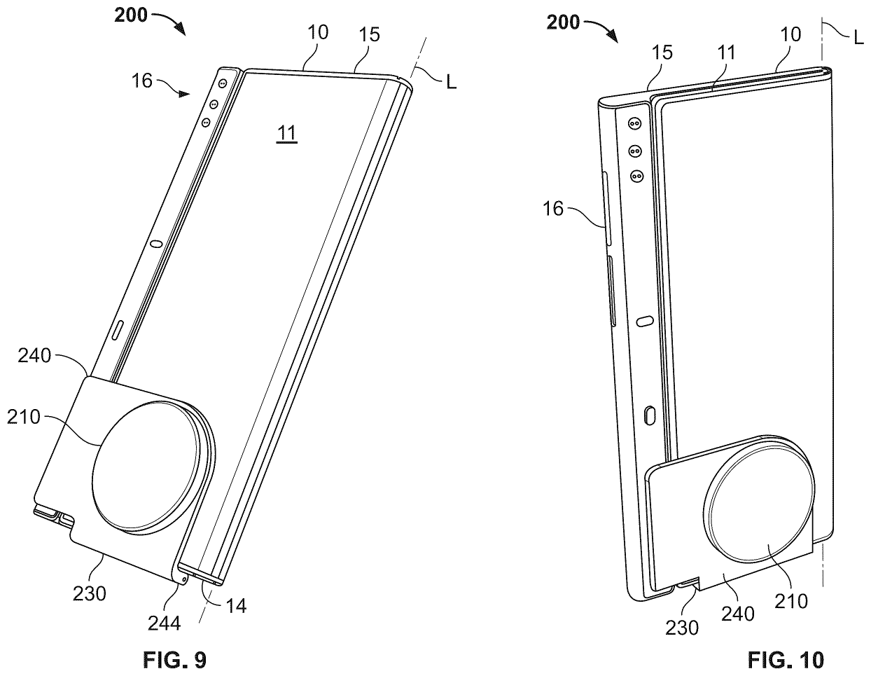

In the illustrated example, the base member 232 is positioned such that the hinge portion 244 is disposed at or near the lower surface 14 of the foldable electronic device 10. In other examples (not shown), the hinge portion 244 may be disposed at or near the upper surface 12 or one of the side surfaces 16. In any of these examples, the pivotable arm 240, which may be removably coupled with the base member 232, is movable between a first configuration (FIGS. 9, 10, and 13) whereby the pivotable arm 240, and thus the button 210, is positioned adjacent to and/or near the foldable electronic device 10 (e.g., the front surface 11 or the rear surface 12). As previously stated, the button 210 may be positioned in an expanded or a collapsed configuration as desired and may have an annular shape. So configured, a user may hold the button 210, and thus the foldable electronic device 10 while the foldable electronic device 10 is in a folded state. In some examples, the pivotable arm 240 may act as a securement mechanism that restricts and/or prevents the foldable electronic device 10 from moving to an unfolded configuration.

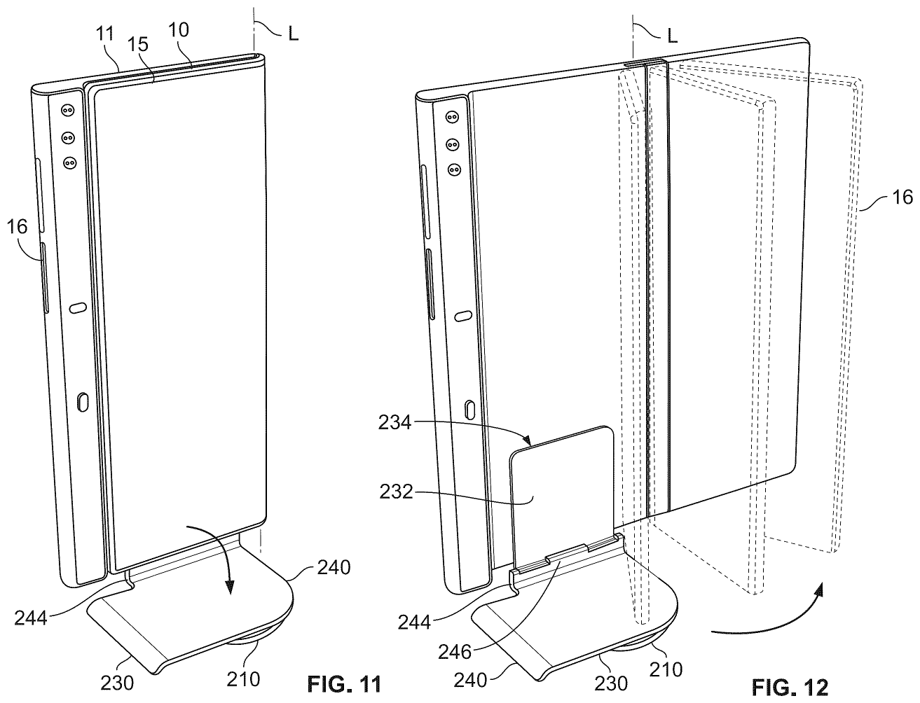

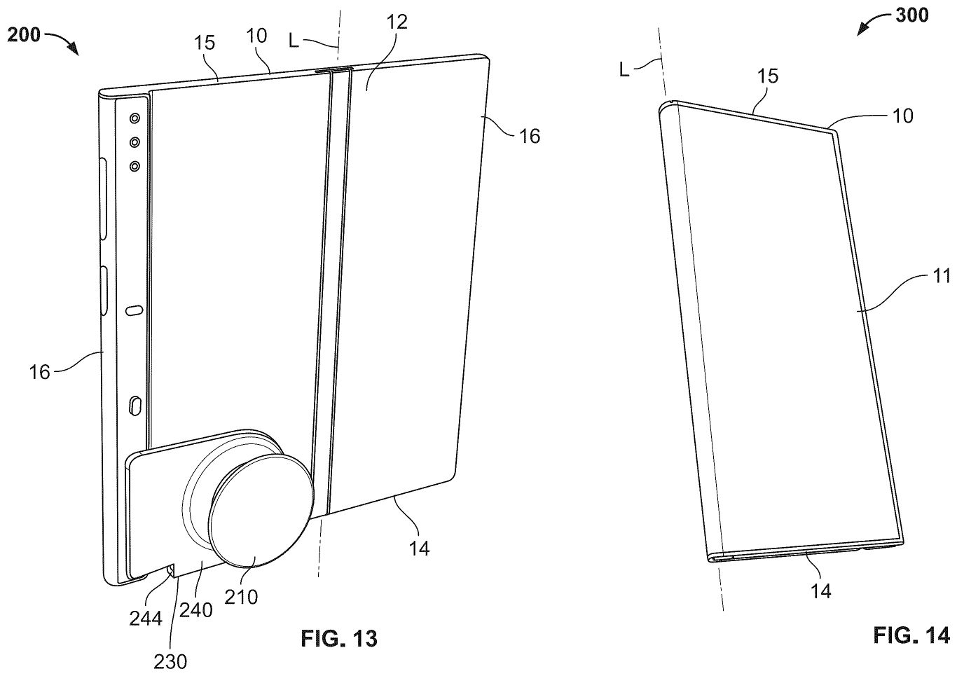

With reference to FIG. 11, as with the expandable device 100, when the user wishes to unfold the foldable electronic device 10, the user may pivot the pivotable arm 240 to the second configuration. In this second configuration, the pivotable arm 240 no longer restricts and/or prevents the foldable electronic device 10 from being unfolded, as the pivotable arm 240 provides ample clearance for the foldable electronic device 10 to move between folded and unfolded configurations as shown in FIG. 12. Upon the foldable electronic device 10 being unfolded, the pivotable arm 240 may be positioned in either the first configuration (FIG. 13) or the second configuration (FIG. 11) as desired. When the pivotable arm 240 is positioned in the first configuration, a user may grasp the button 210 to securely hold the foldable electronic device 10. Additionally, when the pivotable arm 240 is positioned in the second configuration, the pivotable arm 240 may serve as a kickstand to prop and/or retain the foldable electronic device 10 in an upright position. As with base member 132, base member 232 may carry a battery or a battery pack that provides a power source to the device 10.

As with the embodiment of FIGS. 1-7, the hinge portion 244 may additionally include a locking mechanism 246 which may be operably coupled to the base member 232 and/or the pivotable arm 240. The locking mechanism 246 selectively retains the pivotable arm 240 in the first and/or the second configurations. For example, the locking mechanism 246 may be in the form of a resilient member that exerts an urging force on the pivotable arm 240 that retains the pivotable arm 240 in either the first and/or the second configuration. In some examples, the resilient member may be a bistable element that selectively exerts opposing forces to retain the pivotable arm 240 in the first and second configurations. Other examples are possible.

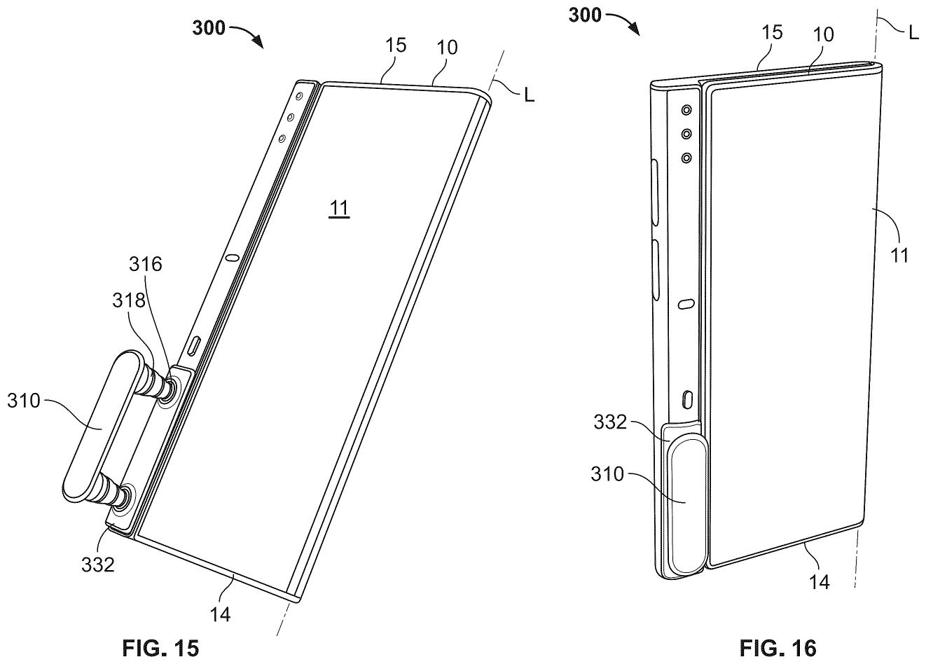

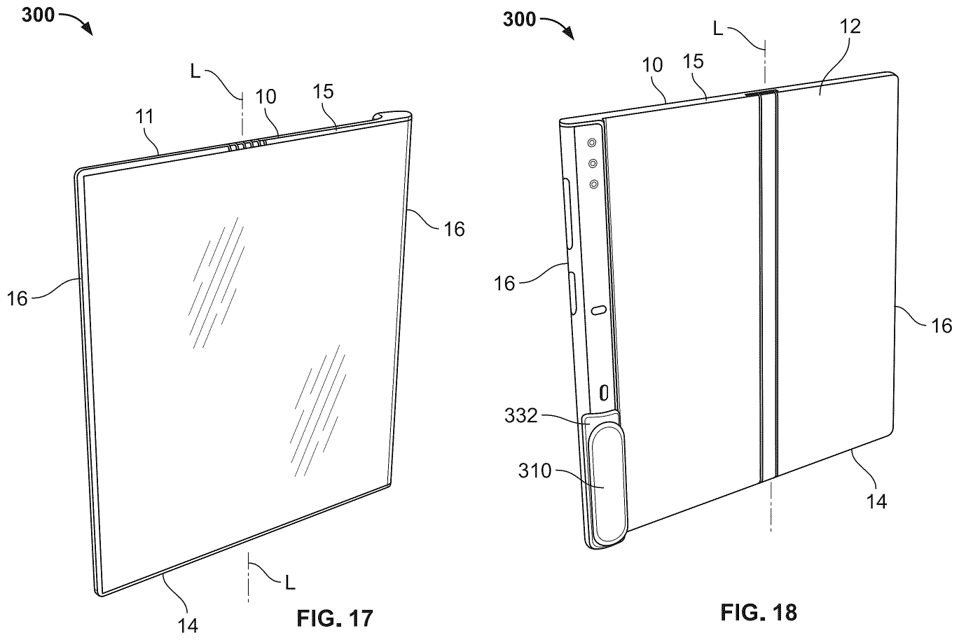

Yet another example of an expandable device 300 coupled to a foldable electronic device is illustrated in FIGS. 14-18. It will be appreciated that the expandable device 300 illustrated in FIGS. 14-18 may include similar features to the expandable devices 100, 200, and accordingly, elements illustrated in FIGS. 14-18 are designated by similar reference numbers indicated in FIGS. 1-13 increased by 100 or 200. Accordingly, these features will not be described in substantial detail. Further, it is appreciated that any of the elements described with regards to the expandable devices 100, 200 may be incorporated into the expandable device 300.

The expandable device 300 does not include a pivotable arm. Rather, an elongated base member 332 is operably coupled to an elongated button 310 via any number of coupling portions 316. Each coupling portion 316 includes a collapsible and/or expandable mechanism or body 318 operably coupled to the button 310 that allows the button 310 to move between expanded and collapsed configurations.

The elongated base member 332 is operably coupled to a portion of the foldable electronic device 10 at a location (e.g., on the rear surface 12 at a location near a side surface 16) that does not interfere with movement of the foldable electronic device 10 between the unfolded and folded configurations. Accordingly, the user may configure the foldable electronic device 10 without repositioning the expandable device 300. As with the expandable devices 100, 200, a user may grasp the button 310 when positioned in an expanded configuration to securely hold the foldable electronic device 10. Additionally, when the button 310 is the expanded configuration, the expandable device 300 may serve as a kickstand to prop and/or retain the foldable electronic device 10 in an upright position.

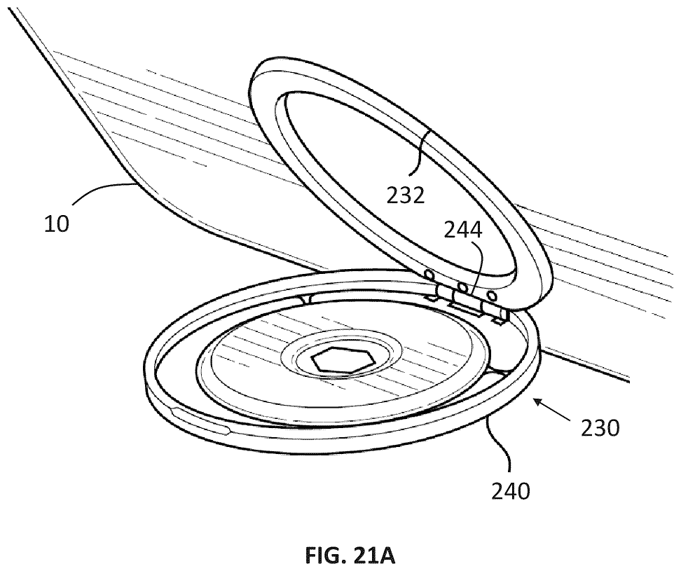

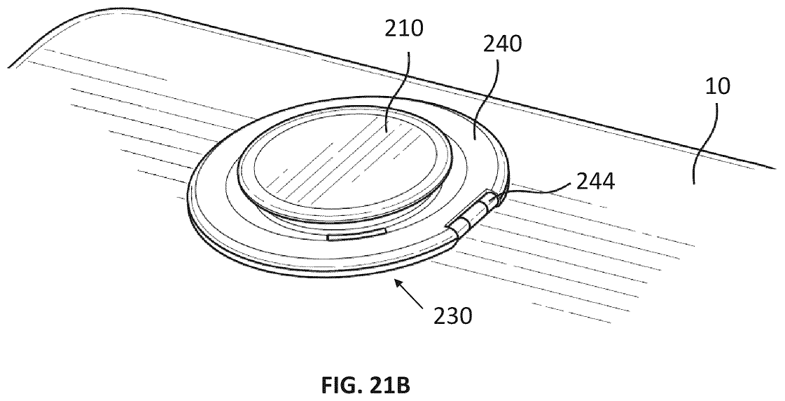

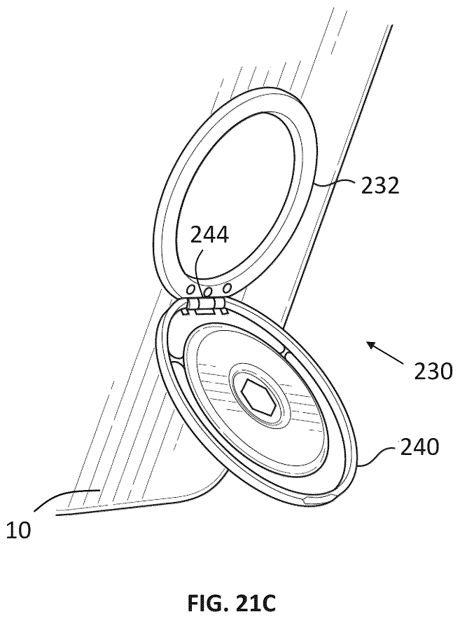

As described above with respect to FIGS. 8-13, the pivotable frame member 230 may have any desired shape and the button 110 may have an annular shape. Moreover, as shown best in FIGS. 1-4, the pivotable arm 140 is substantially the same shape as the button 110 around a majority of the circumference of the button 110. Consistent with that, FIGS. 21A-21C illustrate various views of an expandable device in which the annular shape of the pivotable frame member 230 and pivotable arm 240 continues around the button 110, thereby forming the same annular shape as the button.

As with the embodiment of FIGS. 8-13, FIGS. 21A-21C illustrates that the pivotable arm 240 is coupled to a base portion 232 by a hinge portion 244, whereby the pivotable arm 240 may pivot along the hinge portion 244 between a first configuration (FIG. 21B) and a second configuration (FIGS. 21A and 21C). In the first configuration (FIG. 21B), the pivotable arm 240 is positioned adjacent to and/or near the foldable electronic device 10 and the base portion 232. When the pivotable arm 240 is positioned in the first configuration, a user may grasp the button 210 to securely hold the foldable electronic device 10. In the second configuration (FIGS. 21A and 21C), the pivotable arm 240 is angled away from the foldable electronic device 10 and the base portion 232, as shown in the figures. When the pivotable arm 240 is positioned in the second configuration, the pivotable arm 240 may serve as a kickstand to prop and/or retain the foldable electronic device 10 in an upright position. As previously stated, the button 10 may be positioned in an expanded or a collapsed configuration as desired.

As previously described, the hinge portion 244 may additionally include securing mechanism (not shown) which operably secures the base member 232 and the pivotable arm 240 in one or both of the first configuration and the second configurations. For example, the securing mechanism may exert an urging force on the pivotable arm 240 that retains the pivotable arm 240 in one or both of the first configuration and the second configurations.

In some instances, the expandable device of the current disclosure may at least partly take the form of a commercially available grip and stand product such as that available on www.popsockets.com. For example, U.S. Pat. No. 8,560,031, filed on Feb. 23, 2012; U.S. Pat. No. 9,970,589, filed on Nov. 9, 2017; U.S. application Ser. No. 15/615,900, filed on Jun. 7, 2017 (now U.S. Pat. No. 10,054,259); U.S. application Ser. No. 15/679,934, filed on Aug. 17, 2017 (now U.S. Pat. No. 10,060,573); U.S. application Ser. No. 15/803,410, filed on Nov. 3, 2017 (now U.S. Pat. No. 9,958,107); U.S. application Ser. No. 15/808,076, filed on Nov. 9, 2017 (now U.S. Pat. No. 9,970,589); U.S. application Ser. No. 15/864,402, filed on Jan. 8, 2018 (published as US 2019/0138052); U.S. application Ser. No. 15/864,509, filed on Jan. 8, 2018 (now U.S. Pat. No. 10,463,116); U.S. application Ser. No. 15/906,920, filed on Feb. 27, 2018 (now U.S. Pat. No. 10,215,329); U.S. application Ser. No. 15/922,601, filed on Mar. 15, 2018 (now U.S. Pat. No. 10,030,807); U.S. application Ser. No. 15/952,025, filed on Apr. 12, 2018 (now U.S. Pat. No. 10,386,009); U.S. application Ser. No. 15/993,458, filed on May 30, 2018 (now Patent No. U.S. Pat. No. 10,348,352); and U.S. application Ser. No. 16/001,723, filed on Jun. 6, 2018 (now U.S. Pat. No. 10,317,005) each describe suitable expandable grip and stand products, which also incorporate collapsible mechanisms and may form at least part of the disclosure herein, and therefore the entirety of each is hereby incorporated by reference.

Those skilled in the art will recognize that a wide variety of modifications, alterations, and combinations can be made with respect to the above-described examples without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). what is claimed is:

1. An accessory configured to provide grip and kickstand functionality for a mobile electronic device, the accessory comprising:
a pivotable frame member comprising:
a base member configured to detachably attach to a rear surface of the mobile electronic device or to a rear surface of a case of the mobile electronic device, and
a pivotable arm coupled to the base member at a hinge portion, wherein the pivotable arm pivots along the hinge portion between at least a closed configuration and an open configuration, wherein the pivotable arm comprises a base-facing surface and an opposite accessory-facing surface; and
a grip accessory detachably coupled to the accessory-facing surface of the pivotable arm.

2. The accessory of claim 1, wherein the pivotable arm is positionable as a kickstand for the mobile electronic device when in the open configuration.

3. The accessory of claim 1, wherein the base-facing surface of the pivotable arm is adjacent to the base member when the pivotable arm is in the closed configuration.

4. The accessory of claim 3, wherein the base-facing surface of the pivotable arm is in contact with the base member when the pivotable arm is in the closed configuration.

5. The accessory of claim 1, wherein the grip accessory is movable between an expanded configuration and a collapsed configuration.

6. The accessory of claim 5, wherein the grip accessory in the expanded configuration is configured to be grasped by a user to securely hold the mobile electronic device when the pivotable arm is in the closed configuration.

7. The accessory of claim 5, wherein at least a portion of the grip accessory expands away from the accessory-facing surface of the pivotable arm when moving from the collapsed configuration to the expanded configuration, and contracts towards the accessory-facing surface of the pivotable arm when moving from the expanded configuration to the collapsed configuration.

8. The accessory of claim 5, wherein the grip accessory comprises a top side, a bottom side, and a coupling portion, and wherein the top side of the grip accessory expands away from the accessory-facing surface of the pivotable arm when moving from the collapsed configuration to the expanded configuration, and contracts towards the accessory-facing surface of the pivotable arm when moving from the expanded configuration to the collapsed configuration.

9. The accessory of claim 1, further comprising a securing mechanism configured to retain the pivotable arm in the closed configuration.

10. The accessory of claim 1, wherein the grip accessory comprises an expandable mechanism which is configured to resiliently retain the grip accessory in the closed configured and expanded configuration, respectively.

11. The accessory of claim 1, wherein at least a portion of the pivotable arm of the pivotable frame member is configured in an annular shape.

12. The accessory of claim 11, wherein the base member of the pivotable frame member is configured in an annular shape.

13. The accessory of claim 12, wherein the pivotable arm is positionable as a kickstand for the mobile electronic device when in the open configuration.

14. The accessory of claim 12, wherein the base-facing surface of the pivotable arm is adjacent to the base member when the pivotable arm is in the closed configuration.

15. The accessory of claim 12, wherein the grip accessory is movable between an expanded configuration and a collapsed configuration.

16. The accessory of claim 15, wherein the grip accessory in the expanded configuration is configured to be grasped by a user to securely hold the mobile electronic device when the pivotable arm is in the closed configuration.

17. The accessory of claim 15, wherein at least a portion of the grip accessory expands away from the accessory-facing surface of the pivotable arm when moving from the collapsed configuration to the expanded configuration, and contracts towards the accessory-facing surface of the pivotable arm when moving from the expanded configuration to the collapsed configuration.

18. The accessory of claim 15, wherein the grip accessory comprises a top side, a bottom side, and a coupling portion, and wherein the top side of the grip accessory expands away from the accessory-facing surface of the pivotable arm when moving from the collapsed configuration to the expanded configuration, and contracts towards the accessory-facing surface of the pivotable arm when moving from the expanded configuration to the collapsed configuration.

19. The accessory of claim 12, further comprising a securing mechanism configured to retain the pivotable arm in the closed configuration.

20. The accessory of claim 12, wherein the grip accessory comprises an expandable mechanism which is configured to resiliently retain the grip accessory in the closed configured and expanded configuration, respectively.
